(19) United States
(12) Patent Application Publication
(10) Pub. No.: US 2011/0048470 A1
(43) Pub. Date: Mar. 3, 2011

(54) Spray Assembly for Spraying Foam and Liquid for Cleaning a Surface and Also a Cleaning Installation and Method

(75) Inventor: Hendrik Ronald van Krimpen, Rotterdam (NL)

(73) Assignee: ANRO SPRAY SOLUTIONS, Rotterdam (NL)

(21) Appl. No.: 12/063,931

(22) PCT Filed: Aug. 17, 2006
(86) PCT No.: PCT/NL2006/050203

§ 371 Date: Aug. 13, 2008

(30) Foreign Application Priority Data
Aug. 17, 2005 (NL) 1029753

(51) Int. Cl. B08B 3/02; B05B 3/02

(52) U.S. Cl. 134/34; 239/265; 134/198

(57) ABSTRACT

A spray assembly for spraying foam and liquid for cleaning a surface includes an inlet for letting fluid into the spray assembly, a rotation member which is arranged to be rotatable about a rotational axis with respect to the inlet, at least one outlet connected to the rotation member having a spray orifice located at a distance with respect to the rotational axis for releasing the fluid let into the spray assembly, wherein the spray orifice defines a radial line, the radial line extending through the spray orifice and perpendicular to the rotational axis, and in operation the resultant of the reaction force generated by the released fluid on the outlet is directed at an angle with respect to a plane extending through the radial line and perpendicular to the rotational axis for rotating the rotation member, wherein the spray assembly comprises an outlet-adjusting component for adjusting the outlet with respect to the rotation member in the plane extending through the radial line and perpendicular to the rotational axis.

The present invention relates to a spray assembly for spraying foam and liquid for cleaning a surface, comprising an inlet for letting fluid into the spray assembly, a rotation member, which is arranged to be rotatable about a rotational axis in respect of the inlet, at least one outlet connected to the rotation member and comprising a spray orifice located at a distance in respect of the rotational axis for releasing the fluid let into the spray assembly, wherein the spray orifice defines a radial line, said radial line extending through the spray orifice and perpendicular to the rotational axis, and in operation the resultant of the reaction force generated by the released fluid on the outlet is directed at an angle in respect of a plane extending through the radial line and perpendicular to the rotational axis for rotating the rotation member.

A spray assembly of this type is known and is used, among other things, for spraying foam and liquid for cleaning a surface. Examples of surfaces to be cleaned are tanks, barrels, bottling, packing and can-filling machines in the food industry and areas with specific hygiene requirements (such as storage rooms for pharmaceutical products). For cleaning, a cleaning foam is first sprayed by the spray assembly on to the surface to be cleaned. Then a liquid (usually water) is sprayed on the surface by the same spray assembly, so that the foam is rinsed off the surface. This spraying is caused by the fact that the rotation member of the spray assembly rotates whenever fluid is released through the spray orifice. This rotation is essential to ensure that the entire surface is reached by the sprayed foam or water.

A disadvantage of the known spray assembly is that it does not function as wished when it is used successively with foam and liquid. The desired rotation is not attained when foam and liquid are used. When foam is used the known device rotates inadequately or too fast. This results in the surface to be cleaned being inadequately covered by the cleaning foam. When liquid is used the known device rotates too fast. For this reason, during spraying of the liquid, because the rotation speed of the rotation member is too high, drop formation is too small, whereby the drops of liquid have too little mass and when they reach the surface have too low a speed to rinse off the foam. The difference in functioning of the spray assembly when liquid or foam is used is determined by the different material properties of the foam and the liquid.

Patent GB-A-1.347.659 further discloses a spray device for watering gardens. This device is unsuitable for spraying fluid and particularly unsuitable for spraying foam. The outlet of this known device is adjustable in the plane extending through the rotational axis of the spray device and through the longitudinal axis of the outlet. The outlet can further be rotated about the longitudinal axis thereof. The outlet comprises spray orifices in the side wall, through which the water released through these spray orifices leaves the outlet in a direction perpendicular to the plane extending through the rotational axis of the spray assembly and through the longitudinal axis of the outlet.

One aim of the invention is to obtain a spray assembly which can be used optimally with both foam and liquid. This aim is achieved according to the invention in that the spray assembly comprises outlet-adjusting means for adjusting the outlet in respect of the rotation member in the plane extending through the radial line and perpendicular to the rotational axis.

This provides the user with the option of adjusting the rotation speed of the spray assembly according to the invention. In this way the optimum rotation speed can be achieved with this spray assembly when using both foam and liquid. For optimum functioning it is determined in what position of the outlet the spray assembly works optimally with foam and in what position the spray assembly works optimally with liquid. In operation the outlet is subsequently placed in the position in which the assembly works optimally with foam, whereupon the foam is sprayed by the spray assembly on to the surface to be cleaned. Subsequently the outlet is positioned in the position wherein the spray assembly works optimally with liquid, whereupon the liquid is sprayed on the surface. In this way optimum functioning of the spray assembly is achieved when using both foam and liquid.

An additional advantage is that the spray assembly can also be used for determining the angle of the resultant force F, wherein the spray assembly functions sufficiently well with both foam and water to clean a specific surface. In practice this will be an attractive option, since a great deal of time can be saved because after the spraying of foam it is not necessary to adjust the position of the outlet. With use of this kind the outlet can be kept permanently in one position. If circumstances change, such as different composition of the foam or liquid, it may occur that the spray assembly with the outlet in that specific position no longer functions sufficiently well with both foam and water. By adjusting the position of the outlet in respect of the rotation member, it is easily and quickly possible to determine in what position of the outlet the spray assembly again does function well under the changed circumstances. In this way the spray assembly according to the invention provides a spray assembly, wherein the rotation speed thereof can be set as the user wishes and can be adjusted to the properties of the fluid to be sprayed.

In one embodiment according to the invention the at least one outlet is adjustable such that said angle of said resultant can adopt a value of between 0° and 15° in operation in the plane extending through the radial line and perpendicular to the rotational axis. This angle appears from practical experience to be particularly suitable for use of the spray assembly according to the invention, wherein the spray assembly with the outlet positioned in a specific position works sufficiently well with both foam and liquid.

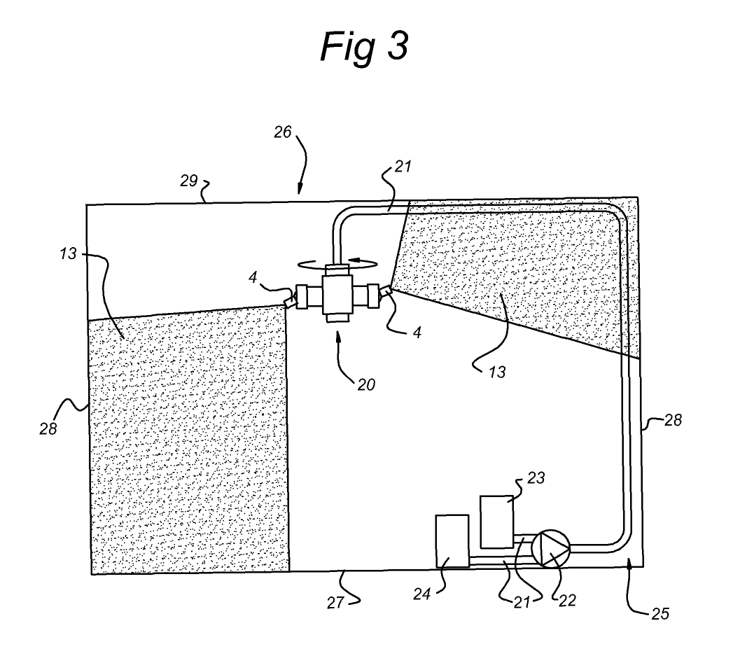

In one embodiment according to the invention the spray assembly comprises second outlet-adjusting means for adjusting the direction of the outlet in respect of the rotation member in a plane extending through the radial line and the rotational axis. Because of the second outlet-adjusting means it is possible to place the outlet in such a position that during rotational spraying by the spray assembly it is primarily directed at a particular area of the surface to be cleaned. This is also very advantageous in the situation where the spray assembly comprises more than one outlet. The different outlets can then be positioned such that each outlet is directed at a specific area of the surface to be cleaned. An example of this is the situation where the surface to be cleaned is a room, the spray assembly has three outlets and wherein the first outlet is principally directed at the floor, the second at the walls and the third at the ceiling. An embodiment with two outlets is described in FIG. 3.

The first and second outlet-adjusting means can be integrated into an embodiment according to the invention and comprise a ball and socket joint. Using a ball and socket joint has the advantage that it is very robust, is easily adjustable and provides greater freedom of movement for the outlets. The at least one outlet can be connected to the rotation member by means of a ball joint. The ball joint can be fixed to the rotation member by a cap nut. Both these measures each have the advantage that a spray assembly with a simple, and yet also compact, structure is achieved.

In one embodiment according to the invention the outlet can comprise nozzle-accommodating means for accommodating a nozzle. In this way it is possible to provide the spray assembly according to the invention with various kinds of nozzles in a simple manner. This is advantageous since specific nozzles are preferred for the different cleaning applications for which the spray assembly can be used. Pointed jet, flat jet and fully conical nozzles come to mind in this respect.

In one embodiment according to the invention the at least one outlet comprises a flat jet nozzle and in operation said outlet releases the fluid substantially at an angle of between [the between the] 0° and 15° in respect of the plane through the radial line and the rotational axis. This embodiment is particularly suitable for use of the spray assembly according to the invention, wherein the outlet of the spray assembly is positioned in a specific position such that it works sufficiently well with both foam and water.

In one embodiment according to the invention the spray assembly can comprise two outlets, said outlets being located in line with one another and in operation releasing the fluid in opposite directions. The specific position of the two outlets in this case has a positive effect on the rotational behaviour of the rotation member.

The invention further relates to a cleaning installation comprising a cleaning agent holder for holding a cleaning agent, a liquid holder for holding a liquid, a spray assembly according to the invention for spraying a fluid, fluid pipes for conducting a fluid and wherein fluid pipes mutually connect the cleaning agent holder, the liquid holder and the spray assembly and a pump is connected to the fluid pipes to pump cleaning agent and liquid to the spray assembly.

The invention further relates to a method for cleaning a surface, including the steps of rotary spraying of a surface with a fluid by at least one spray assembly comprising an outlet releasing a fluid, wherein the spray assembly comprises a rotation member and the resultant of the reaction force generated by the released fluid on the outlet is directed at an angle in respect of a plane extending through the radial line and perpendicular to the rotational axis of the spray assembly for rotating the rotation member, and adjusting the outlet in respect of the rotation member in the plane extending through the radial line and perpendicular to the rotational axis for adjusting the rotation speed of the spray assembly.

In one embodiment of the method according to the invention the step of adjusting the outlet involves adjusting said outlet such that said angle adopts a value of between 0° and 15°.

One embodiment of the method according to the invention comprises the step of adjusting the direction of the outlet in respect of the rotation member in a plane extending through the radial line and the rotational axis for directing the outlet at a particular part of the surface to be cleaned.

The invention will be explained in more detail with the aid of the drawings, in which

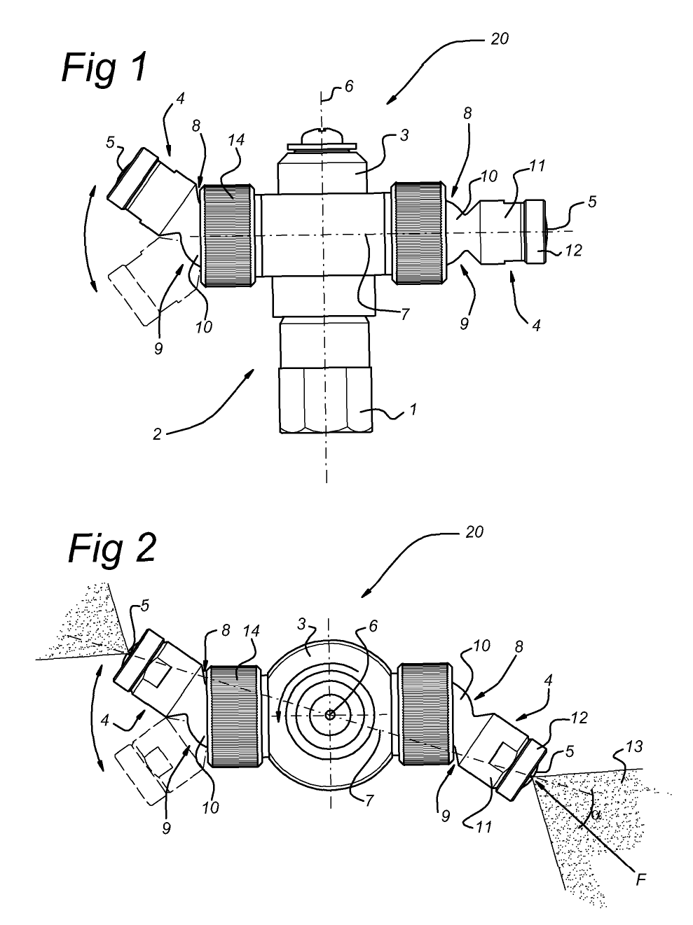

FIG. 1 is a schematical side view of a spray assembly according to the invention,

FIG. 2 is a schematical top view of the spray assembly of FIG. 1 in the situation where liquid is being released through the outlets and

FIG. 3 is a schematical reproduction of a cleaning installation comprising the spray assembly of FIG. 1.

FIG. 1 shows a spray assembly 20 according to the invention, comprising an inlet 2 for letting fluid into the spray assembly 20. The inlet 2 comprises fixing means 1 for connecting the spray assembly 20 to a fluid supply (not shown). Via the inlet 2 the fluid is conducted into the rotation member 3, said rotation member 3 being arranged to be rotatable about a rotational axis 6 in respect of the inlet 2. In the rotation member 3 the fluid is conducted in the direction of the two outlets 4 and then released through the spray orifices 5. Each outlet 4 is connected to the rotation member 3 by means of a ball and socket joint 10. The ball and socket joint 10 is fixed to the rotation member 3 by a cap nut 14. In this way a spray assembly 20 with a simple and also compact structure is achieved.

The ball and socket joint 10, in integrated form, forms the outlet-adjusting means 8 and the second outlet-adjusting means 9 of the spray assembly 20. The arrow shown in FIG. 1 near the left outlet 4 and the different positions reproduced of said outlet 4 show the adjustability of the outlets 4 in the plane extending through the radial line 7 and the rotational axis 6. The outlets 4 further comprise nozzle-accommodating means 11 for accommodating a nozzle 12. By using ball joints 10 it is possible to rotate the outlets 4 about the longitudinal axis of the outlets 4, which can be advantageous for directing the fluid released by the nozzles. This is principally advantageous with nozzles which release the fluid in a specific direction, such as flat jet nozzles.

FIG. 2 shows a top view of the spray assembly 20 of FIG. 1 in the situation where liquid is being released through the outlets 4. The arrow shown near the left outlet 4 and various positions of said outlet 4 reproduced show the adjustability of the outlets 4 in the plane extending through the radial line 7 and perpendicular to the rotational axis 6. Liquid 13 is released through the spray orifices 5 of the outlets 4. The resultant F of the reaction force generated by the released liquid 13 on the outlets 4 is directed at an angle α. In this way the rotation member 3 will rotate in the direction of the arrow shown near the rotation member 3. In the spray assembly 20 shown the rotation member 3 principally comprises Teflon and the remaining members are made of stainless steel.

FIG. 3 shows a schematical reproduction of a cleaning installation in operation and comprising the spray assembly 20 of FIG. 1. The cleaning installation 25 is depicted in an area 26 comprising a floor 27, two walls 28 and a ceiling 29. The cleaning installation 25 comprises a spray assembly 20, fluid pipes 21, a pump 22, a liquid holder 23 and a cleaning agent holder 24. The liquid holder 23 and the cleaning agent holder 24 are each connected to the pump 22 by means of a fluid pipe 21 for pumping liquid and/or cleaning agent to the spray assembly 20. The pump 22 is for this purpose connected to the spray assembly 20 by a fluid pipe 21, wherein said fluid pipe 21 fixes the spray assembly 20 to the ceiling 29. By pumping liquid and/or cleaning agent, fluid 13 is released through the two outlets 4 of the spray assembly 20. By this means the spray assembly 20 will rotate about the desired surface of the area to be sprayed. The two outlets 4 are positioned in different positions. One of the outlets 4 is positioned such that it principally sprays the ceiling 29 and the top part of the walls 28 and the other outlet 4 is positioned such that it principally sprays the bottom part of the walls 28. In the situation shown, when liquid is applied the pressure of the liquid supplied to the spray assembly 20 is between 6 and 20 bar. When foam is applied the pressure of the foam supplied to the spray assembly 20 is between 1 and 5 bar. The cleaning installation can further also comprise a gas-holder (not shown), said gas-holder being connected to the pump for adding a gas to the foam. If it is desired to add air to the foam, as an alternative to this, the pump can comprise air intake means (not shown) for adding air to the foam. The adding of gas to the foam can be used to achieve a “fluffing up” effect of the foam.

It will be clear to the person skilled in the art that many variants are conceivable within the scope of the extent of protection defined by the claims.

1-14. (canceled)

15. A spray assembly for spraying foam and liquid for cleaning a surface, comprising:
an inlet for letting fluid into the spray assembly;
a rotation member which is arranged to be rotatable about a rotational axis with respect to the inlet;
at least one outlet connected to the rotation member and having a spray orifice located at a distance with respect to a rotational axis for releasing the fluid let into the spray assembly, wherein the spray orifice defines a radial line, said radial line extending through the spray orifice and perpendicular to the rotational axis, and in operation the resultant of a reaction force generated by the released fluid on the outlet is directed at an angle with respect to a plane extending through the radial line and perpendicular to the rotational axis for rotating the rotation member; and
an outlet-adjusting component for adjusting the outlet with respect to the rotation member in a plane extending through the radial line and perpendicular to the rotational axis.

16. The spray assembly according to claim 15, wherein the at least one outlet is adjustable such that said angle of said resultant can adopt a value of between 0° and 15° in operation in the plane extending through the radial line and perpendicular to the rotational axis.

17. The spray assembly according to claim 15, wherein the spray assembly comprises a second outlet-adjusting component for adjusting the direction of the outlet with respect to the rotation member in a plane extending through the radial line and the rotational axis.

18. The spray assembly according to claim 17, wherein the first and second outlet-adjusting components are integrated and comprise a ball and socket joint.

19. The spray assembly according to claim 18, wherein the at least one outlet is connected to the rotation member by the ball and socket joint.

20. The spray assembly according to claim 18, wherein the ball and socket joint is fixed to the rotation member by a cap nut.

21. The spray assembly according to claim 19, wherein the ball and socket joint is fixed to the rotation member by a cap nut.

22. The spray assembly according to claim 15, wherein the at least one outlet comprises a nozzle-accommodating component for accommodating a nozzle.

23. The spray assembly according to claim 17, wherein the at least one outlet comprises a nozzle-accommodating component for accommodating a nozzle.

24. The spray assembly according to claim 15, wherein the at least one outlet comprises a flat jet nozzle and said outlet releases the fluid in operation substantially at an angle of between 0° and 15° with respect to a plane extending through the radial line and the rotational axis.

25. The spray assembly according to claim 17, wherein the at least one outlet comprises a flat jet nozzle and said outlet releases the fluid in operation substantially at an angle of between 0° and 15° with respect to a plane extending through the radial line and the rotational axis.

26. The spray assembly according to claim 15, wherein the spray assembly comprises two outlets which are located in line with one another and in operation release the fluid in opposite directions.

27. The spray assembly according to claim 16, wherein the spray assembly comprises two outlets which are located in line with one another and in operation release the fluid in opposite directions.

28. The spray assembly according to claim 17, wherein the spray assembly comprises two outlets which are located in line with one another and in operation release the fluid in opposite directions.

29. The spray assembly according to claim 15, made of Teflon and/or stainless steel.

30. A cleaning installation comprising:
a cleaning agent holder for holding a cleaning agent;
a liquid holder for holding a liquid;
a spray assembly according to claim 15 for spraying a fluid;
fluid pipes for conducting a fluid and wherein the fluid pipes mutually connect the cleaning agent holder, liquid holder and spray assembly and connected to the fluid pipes is a pump for pumping cleaning agent and liquid to the spray assembly.

31. A method for cleaning a surface comprising the steps of rotary spraying a surface with a fluid by at least one spray assembly comprising an outlet releasing a fluid, wherein the spray assembly comprises a rotation member and the resultant of the reaction force generated by the released fluid on the outlet is directed at an angle with respect to a plane extending through a radial line and perpendicular to a rotational axis of the spray assembly for rotating the rotation member; adjusting the outlet with respect to the rotation member in the plane extending through the radial line and perpendicular to the rotational axis for adjusting the rotation speed of the spray assembly.

32. The method according to claim 31, wherein the step of adjusting the outlet comprises adjusting said outlet such that said angle adopts a value of between 0° and 15°.

33. The method according to claim 31, comprising the step of adjusting the direction of the outlet with respect to the rotation member in a plane extending through the radial line and the rotational axis for directing the outlet at a particular part of the surface to be cleaned.

34. The method according to claim 32, comprising the step of adjusting the direction of the outlet with respect to the rotation member in a plane extending through the radial line and the rotational axis for directing the outlet at a particular part of the surface to be cleaned.
